(19) United States
(12) Patent Application Publication
(10) Pub. No.: US 2005/0050478 A1
(43) Pub. Date: Mar. 3, 2005

(54) Keypad and methods of operation

(76) Inventors: William Beierwaltes, Loveland, CO (US); Scott Hesse, Longmont, CO (US); Hugh P. Adamson, Boulder, CO (US)

Correspondence Address: ALPINE LAW GROUP, LLC, 9249 S. BROADWAY BLVD, UNIT 200-201, HIGHLANDS RANCH, CO, 80129, US

(21) Appl. No.: 10/793,596

(22) Filed: Mar. 3, 2004

Related U.S. Application Data
(60) Provisional application No. 60/499,226, filed on Aug. 29, 2003.

(51) Int. Cl. G06F 15/00

(52) U.S. Cl. 715/968

(57) ABSTRACT

Exemplary implementations of a building automation keypad described and claimed herein comprise a processor for executing computer-readable program code provided on computer-readable storage. The computer-readable program code includes program code for receiving an identification signal indicating a selected function; program code for identifying at least one automation device corresponding to the selected function; program code for receiving a separate identification signal indicating an adjustment to the selected function; and program code for generating a device command for the at least one automation device based on the indicated adjustment.

### PRIORITY APPLICATION

This application claims priority to co-owned U.S. Provisional Patent Application Ser. No. 60/499,226 for “KEYPAD FOR BUILDING AUTOMATION” of Hugh P. Adamson, et al. (Attorney Docket No. CN1-010USP1), filed Aug. 29, 2003, hereby incorporated herein for all that it discloses.

### TECHNICAL FIELD

The described subject matter relates to keypads in general, and more particularly to keypads and methods of operation.

### BACKGROUND

The ability to automatically control one or more functions in a building (e.g., lighting, heating, air conditioning, security systems) is known as building automation. Building automation systems may be used, for example, to automatically operate various lighting schemes in a house. Of course building automation systems may be used to control any of a wide variety of other functions.

Indeed, building automation systems may be configured to control numerous, elaborate functions and often require the use of a server computer. However, these implementations are typically limited to sophisticated users. Alternatively, various “smart” devices (e.g., a programmable thermostat) may be provided. However, even these may still be daunting to some users and are seldom used by visitors. The user therefore does not realize the full potential of the “smart” device.

Other implementations may include preprogrammed devices. However, preprogrammed devices may require a manufacturer or installer to guess which settings the user will desire, and may require service technicians to make adjustments for the user. According to any of these implementations, the user sacrifices convenience and/or control.

### SUMMARY

Implementations described and claimed herein provide a building automation keypad device. The building automation keypad device may include a processor for executing computer-readable program code provided on computer-readable storage. The computer-readable program code includes: program code for receiving an identification signal indicating a selected function; program code for identifying at least one automation device corresponding to the selected function; program code for receiving a separate identification signal indicating an adjustment to the selected function; and program code for generating a device command for the at least one automation device based on the indicated adjustment.

Another exemplary implementation of a building automation keypad device comprises a housing having a plurality of function elements and a plurality of adjustment elements. A label area is formed in the housing adjacent the plurality of function elements. A colored background is provided for the label area, the colored background generated by an imaging device to substantially match a mounting surface adjacent for the housing.

In another exemplary implementation, a method is provided. The method may be implemented to receiving an identification signal indicating a function selected at a keypad, identifying at least one automation device corresponding to the selected function, receiving a separate identification signal indicating an adjustment to the selected function, and generating a device command for the at least one automation device based on the indicated adjustment.

### BRIEF DESCRIPTION OF THE DRAWINGS

FIG. 1 is a functional block diagram of an exemplary keypad device as it may be implemented in a building automation system; and

FIG. 2a is front plan view of an exemplary keypad device;

FIG. 2b is a back plan view of the exemplary keypad device shown in FIG. 2a;

FIG. 3 is a flow chart of operations that may be implemented with an exemplary keypad device.

### DETAILED DESCRIPTION

Briefly, the invention enables a user to readily control complex functions at a device as simple to use as a keypad. In an exemplary implementation, a keypad device is provided with a plurality of function elements and corresponding adjustment elements. The user selects a function (e.g., lighting control) and is then able to make adjustments to the selected function (e.g., party mode, reading mode). Accordingly, the user does not sacrifice convenience or control. These and other implementations are described in more detail below with reference to the figures.

Although exemplary implementations are described herein with reference to building automation systems, it should be understood that the scope is not limited to use with building automation systems and the invention may also find application in a number of different types of automation systems now known or later developed.

Exemplary Implementation

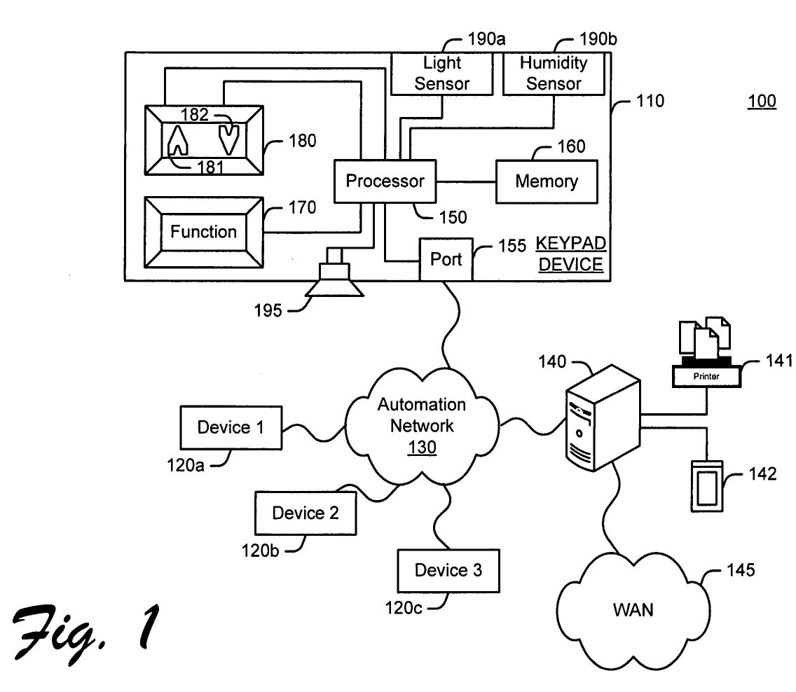

FIG. 1 is a functional block diagram of an exemplary keypad device as it may be implemented in a building automation system. Building automation system 100 may include keypad device 110 linked to a number of automation devices 120a-c via a network or bus (referred to herein as a building automation network 130). Automation devices 120a-c may include any of a wide variety of automation devices, such as, lighting controls, motors that operate window blinds or curtains, multimedia devices (e.g., CD players, DVD players, televisions), security systems, irrigation systems, to name only a very few automation devices that may be implemented in a building automation system. Of course the building automation system 100 is not limited to any particular number or type of automation devices 120a-c.

It is noted that the keypad device 110 is not limited to automation devices 120a-c on the building automation network 130. Keypad device 110 may also be used with other devices outside the building automation network 130 such as, e.g., Ethernet or infrared (IR) devices. In addition, other devices may also send commands or requests for data to the keypad device 110. For purposes of illustration, a thermostat may poll an optional temperature sensor at the keypad device 110 for the current temperature. In another illustration, a light controller may instruct the keypad device 110 to flash an LED at the keypad device 110 to indicate to the user when a light bulb needs to be replaced. Still other implementations are also contemplated and are not limited to these illustrations.

In an exemplary implementation, building automation network 130 may be implemented with a CAN bus (or a number of CAN bus subnetworks). Such an implementation is described in co-owned U.S. patent application Ser. No. 10/382,979 to Hesse et al., and entitled “Building Automation System and Method.” However, it is understood that the invention is not limited to use with any particular type of building automation network 130, and other building automation networks now known or later developed are also contemplated.

A bridge apparatus 140 may also be connected to the building automation network 130. Bridge apparatus 140 may be implemented, e.g., as a server computer, although other implementations are also contemplated. For example, another implementation of a bridge apparatus is described in co-owned U.S. Provisional Patent Application Ser. No. 60/466,564 to Craig Ogawa, and entitled “Bridge Apparatus and Methods of Operation.” Bridge apparatus 140 may link the building automation system 100 to another network 145, such as, e.g., an Ethernet or other local area network (LAN), and/or the Internet or other wide area network (WAN). Bridge apparatus may also be connected to any of a wide variety of peripheral devices, such as, e.g., printer 141 and electronic imaging device or scanner 142.

Continuing with reference to FIG. 1, keypad device 110 may include a processor (or processing units) 150. Processor 150 may be communicatively coupled to the building automation network 130 via port 155, e.g., to send and receive control signals and/or data signals which may be embodied as carrier waves. Processor 150 may also be operatively associated with computer-readable storage 160. Computer-readable storage 160 may include, e.g., non-volatile memory such as FLASH memory and/or battery-backed SRAM.

Keypad device 110 may also include one or more function buttons 170 (or sensing elements) and corresponding adjustment button(s) 180 (or sensing elements). Function button(s) 170 and adjustment button(s) 180 may be activated, e.g., by depressing a mechanical button on the keypad which sends an identification signal to the processor 150 indicating that the mechanical button was depressed.

Function buttons 170 may be activated to select a function. For example, function buttons may be used to select lighting controls or multimedia controls, to name only a few exemplary functions. Adjustment buttons 180 may then be used to make adjustments to the selected function, e.g., using arrows 181, 182 or buttons on an active display such as an LCD or TFT. For example, the user may dim the lighting, raise and lower the volume for the sound system, or open/close curtains. Or for example, the user may scroll through predetermined lighting schemes (e.g., party mode, reading mode), or select a type of music (e.g., party mix, relaxation).

Processor 150 may be implemented to execute computer-readable program code, e.g., stored on computer-readable storage 160. The computer-readable program code may include program code for identifying one or more automation devices 120a-c (e.g., lighting controllers) associated with an activated function button 170. The computer-readable program code may include program code for generating and issuing device commands to automation device(s) 120a-c based on the activated function button(s) 170 and corresponding adjustment button(s) 180.

Computer readable program code may be implemented as scripts. Scripts are computer-readable program code optimized for programmer efficiency (e.g., it is relatively easy to write, flexible, and readily modified). Scripts are preferably independent of the type of processor and/or operating system and are therefore portable to a variety of different environments.

Exemplary implementations of scripts used in building automation systems are described in co-owned U.S. patent application Ser. No. 10/422,525 to Kiwimagi, et al., and entitled “Distributed Control Systems and Methods.” However, it is noted that the computer-readable program code is not limited to scripts, and other implementations of program code now known or later developed may also be used.

In operation, the processor 150 receives identification signals from the activated button(s) 170, 180. Processor 150 executes program code for identifying which of the automation devices 120a-c are associated with the activated button(s) 170, 180, e.g., using a lookup table (LUT) stored in memory 160. Processor 150 also executes program code for generating and issuing a device command including instructions for the automation devices 120a-c based on the activated button(s) 170, 180. Alternatively, the keypad may generate and issue a device command including an event indicating a key press or key release.

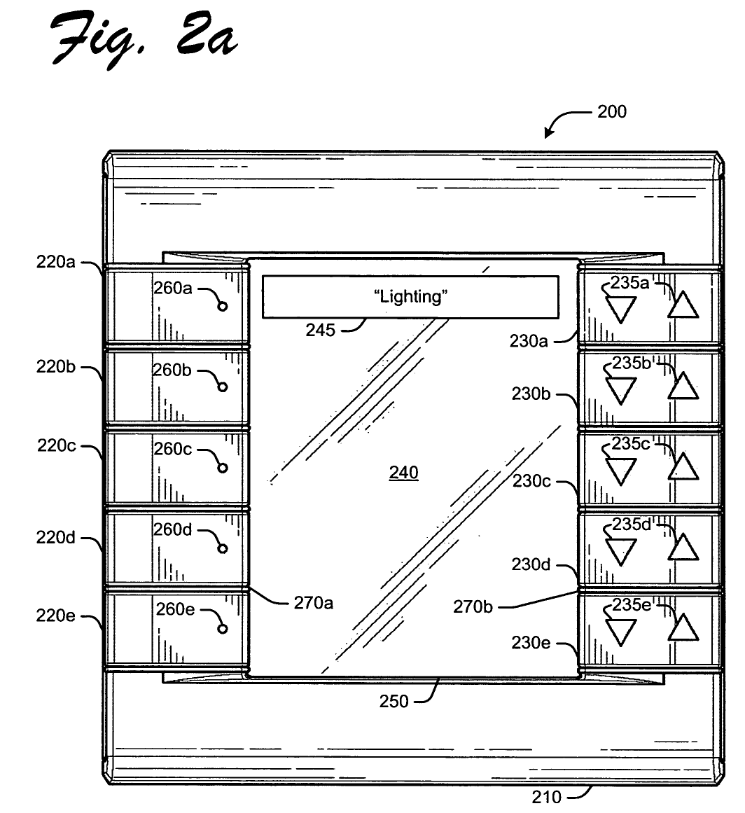

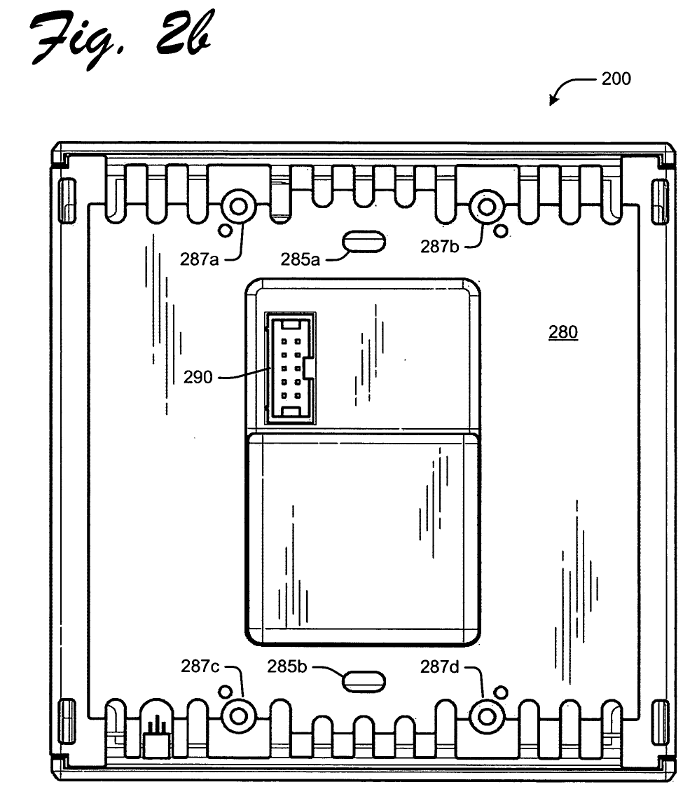

For purposes of illustration, a lighting control function button 170 may be activated by a user. The processor 150 receives an identification signal from the activated lighting control function button and executes program code to identify the associated lighting control automation devices 120a-c. Processor 150 may also activate a light emitting diode (e.g., LEDs 260a-e in FIG. 2a) adjacent the activated lighting control function button 170 to indicate for a user which of the function buttons 170 are activated.

The user may then activate an adjustment button 180 associated with the activated function button 170, e.g., by depressing one of the up/down arrows 181, 182. The processor 150 receives an identification signal from the activated adjustment button 180 and executes program code to generate and issue a corresponding device command to the automation devices identified by the function button 170. For example, the device command may be issued to bridge apparatus 140 to retrieve a music selection, which may then be streamed to the sound system (e.g., one or more of the automation devices 120a-c).

In an alternative implementation, the keypad device 110 may generate and issue an event notification to the automation devices 120a-c in response to buttons 170, 180 being activated by the user. The event notification indicates to the automation devices 120a-c which of the buttons 170, 180 are activated and program code residing at the building automation devices 120a-c is executed by a processor operatively associated with the automation devices 120a-c, e.g., to open/close curtains, execute a lighting scheme, etc.

Keypad device 110 may also be operatively associated with one or more optional sensors. For example, a light sensor 190a may provide illumination level data to the keypad device 110, or a humidity sensor 190b may provide humidity data to the keypad device 110.

Optional sensor(s) 190a, 190b may provide input to the keypad device 110. The input may be used in combination with user-selected functions and/or adjustments to generate device commands. For example, the light sensor may provide illumination level data for a room to the processor 150. The processor 150 may use the illumination level data to adjust the lighting intensity. In another example, the processor 150 may use the illumination level data to adjust the LED intensity (e.g., brighter during daylight and dimmer in the dark).

Of course other types of sensors and/or data devices (not shown) may also be provided, including but not limited to temperature sensors, clocks, and electronic calendars. Optionally, a sounder 195 (e.g., piezo, speaker, etc.) may also be provided for audible feedback, e.g., when the user presses a button.

Although the optional sensors 190a, 190b are shown in FIG. 1 connected directly to the processor 150, other implementations are also contemplated. For example, one or more of the optional sensors 190a, 190b may be provided elsewhere in the building automation network 130, e.g., at a device 120a or at another keypad device (not shown), and the processor 150 may receive input from the optional sensors via port 155 or other link, e.g., a wireless port (not shown).

FIG. 2a is front plan view of an exemplary keypad device 200. Keypad device 200 may include a housing 210 having a plurality of function buttons 220a-e associated with a plurality of adjustment buttons 230a-e. Adjustment buttons 230a-e may include scroll portions 235a-e (e.g., up/down arrows). For example, rocker switches (not shown) may be provided behind the adjustment buttons 230a-e to implement scroll capability.

Optionally, housing 210 may be manufactured of a paintable material. Accordingly, the keypad device 200 may be made to match the wall color (or pattern) in the room where the keypad device 200 is installed. It is noted, however, that the housing 210 is not limited to being manufactured from any particular type of material.

Housing 210 may define a label area 240 adjacent the function buttons 220a-e. Labels 245 identifying the function buttons 220a-e may be printed on paper or plastic (or other suitable media) using a conventional printer (e.g., printer 141 in FIG. 1). Labels 245 may be adhered to the label area 240, e.g., using a removable adhesive or a transparent cover over the label area 240.

Optionally, label area 240 may include a colored background 250 that matches the wall color (or pattern) in the room where the keypad device 200 is installed. In an exemplary implementation, an imaging device (e.g., the scanner 142 in FIG. 1) may be used to image an area of the wall in the room where the keypad 200 is installed. The imaged area may then be used to generate a background 250 that substantially matches the wall color (or pattern), and printed, e.g., using a conventional inkjet or color laser printer (e.g., the printer 141 in FIG. 1).

In an exemplary implementation, housing 210 may be configured to overlap the label area 240. Background 250 can be inserted in label area 240 so that the edges of background 250 are hidden from view, e.g., to hide any ragged edges of background 250.

Keypad device 200 may also include indicators 260a-e (e.g., LEDs, incandescent lights, speakers) mounted adjacent function buttons 220a-e to indicate which buttons are activated. In an exemplary implementation, the intensity of the LEDs 260a-e may be adjusted by the user. For example, a user may desire very bright LEDs so that the keypad 200 can be readily viewed in the dark. Another user may desire dimmer LEDs so that the keypad device 200 does not interfere with their sleep. In another exemplary implementation, the intensity of the LEDs 260a-e may be adjusted automatically (e.g., by the processor 150 in FIG. 1) based on input from a light sensor (e.g., the light sensor 190a in FIG. 1) or other sensor or timing device provided at the keypad or elsewhere on a network.

Keypad 200 may also include a luminescent web 270a between function buttons 220a-e and a luminescent web 270b between adjustment buttons 230a-e. The luminescent web 270a, 270b illuminates the keypad 200 so that the keypad can be found in a dark room. The luminescence may be derived from a luminescent pigment molded into the web plastic. Alternatively, the luminescent web 270a, 270b may be illuminated using a light source, e.g., provided behind a translucent material.

FIG. 2b is a back plan view of the exemplary keypad device 200 shown in FIG. 2a. As shown in FIG. 2b, keypad device 200 may also include a backplate 280 for mounting a PC board (not shown) with control circuitry and the housing 210. The PC board and housing 210 may be mounted, e.g., with screws provided through holes 287a-d formed in backplate 280. The keypad device 200 may also be mounted to a wall or other surface, e.g., with screws provided through holes 285a, 285b formed in backplate 280. Keypad device 200 may also include a connector 290 to connect the keypad device 200 to a building automation network (such as the building automation network 130 in FIG. 1). Power may also be provided to the keypad device 200 via connector 290 or another connector (not shown).

It is noted that the keypad device 200 shown and described with reference to FIGS. 2a and 2b is merely illustrative of an exemplary keypad device that may be used. Other implementations are also contemplated and are not limited to any particular configuration. For example, the keypad device may be implemented as a thin film transistor (TFT) device, wherein touch sensitive controls or “buttons” are displayed as graphical icons or text on a TFT screen. Commercially available touch-sensitive techniques include resistive circuitry wherein pressure is required to short spaced membranes, and capacitive circuitry wherein pressure is not required and instead a connection to the body de-tunes the capacitance. The icons may be selected using a pointing device (e.g., a stile) or the user may simply touch the TFT screen with his or her finger.

Exemplary Operations

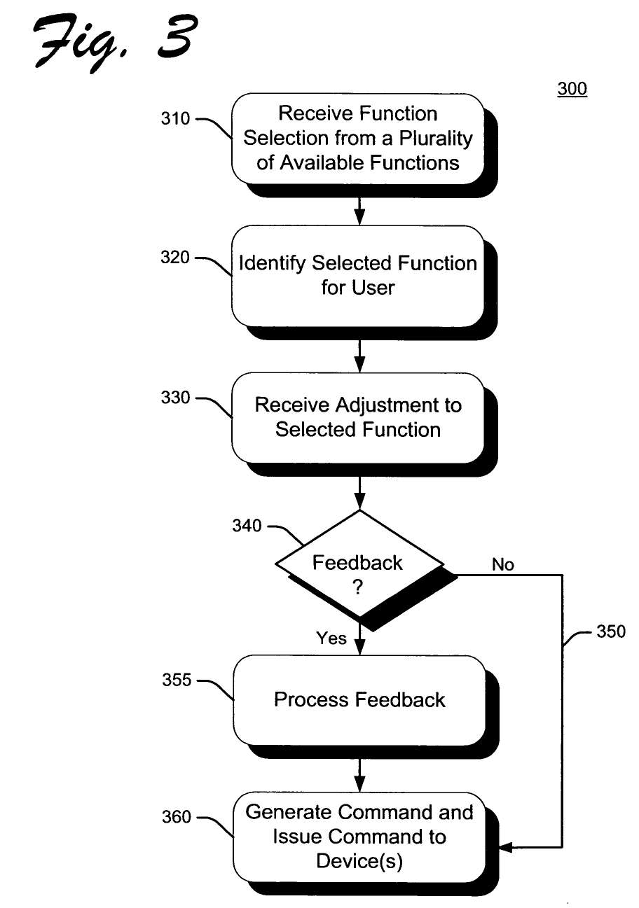

FIG. 3 is a flow chart of operations 300 that may be implemented by an exemplary keypad device. In an exemplary embodiment, the operations may be implemented by computer-readable program code stored in computer-readable storage and executed on a processor (or processing units) at a keypad device, such as the keypad device 110 shown in FIG. 1.

In operation 310 a signal is received by a processor indicating a selected function. The function may be selected by a user from among a plurality of available functions. For example, the user may press a function button on a keypad device causing a signal to be delivered to the processor. In operation 320, the selected function may be optionally indicated to the user. For example, the processor may provide visual feedback to the user by lighting an LED adjacent the selected function button, although other indicators are also contemplated (e.g., audio).

In operation 330 a signal is received by the processor indicating an adjustment to the selected function. The adjustment may be selected by the user from among a plurality of available adjustments to the function. For example, the user may press and hold an adjustment button to scroll through a plurality of lighting modes, letting go of the adjustment button to select the desired lighting mode.

In operation 340 the processor may receive input or feedback from an optional sensor (e.g., light sensor 190a, 190b in FIG. 1). Operations proceed, as illustrated by arrow 350, to operation 360 if the processor does not receive feedback from an optional sensor. In operation 360 a command may be generated, e.g., by the processor, and issued to one or more devices in the building automation system. Alternatively, the command may be retrieved from memory based on the selected function and adjustment signals.

If on the other hand the processor receives feedback from an optional sensor, the feedback is processed in operation 355. For example, the illumination level for a selected lighting mode may need to be increased based on feedback received from a light sensor indicating that it is dark outside. Again in operation 360 a command is generated (or retrieved from memory), this time based at least in part on feedback from the optional sensor.

In addition to the specific implementations explicitly set forth herein, other aspects and implementations will be apparent to those skilled in the art from consideration of the specification disclosed herein. It is intended that the specification and illustrated implementations be considered as examples only, with a true scope and spirit of the following claims.

1. A building automation keypad device comprising:
a processor for executing computer-readable program code provided on computer-readable storage, the computer-readable program code including:
program code for receiving an identification signal indicating a selected function;
program code for identifying at least one automation device corresponding to the selected function;
program code for receiving a separate identification signal indicating an adjustment to the selected function; and
program code for generating a device command for the at least one automation device based on the indicated adjustment.

2. The building automation keypad device of claim 1, wherein the device command includes at least one instruction for a building automation device.

3. The building automation keypad device of claim 1, wherein the device command identifies the selected function for a building automation device.

4. The building automation keypad device of claim 1, wherein the device command identifies the adjustment to the selected function for a building automation device.

5. The building automation keypad device of claim 1, wherein the computer-readable program code further includes program code for issuing the device command to the at least one automation device.

6. The building automation keypad device of claim 1, further comprising a plurality of function sensing elements, the selected function corresponding to one of the plurality of function sensing elements.

7. The building automation keypad device of claim 1, further comprising a plurality of adjustment sensing elements, the adjustment to the selected function corresponding to one of the plurality of adjustment sensing elements.

8. The building automation keypad device of claim 1, wherein the computer-readable program code further includes program code for generating the device command based at least in part on input from a sensor.

9. The building automation keypad of claim 1, further comprising program code for indicating the selected function for a user.

10. A building automation keypad device comprising:
a housing having a plurality of function elements and a plurality of adjustment elements;
a label area formed in the housing adjacent the plurality of function elements;
a colored background for the label area, the colored background generated by an imaging device to substantially match a mounting surface adjacent for the housing.

11. The building automation keypad of claim 10, wherein the housing includes a luminescent web.

12. The building automation keypad of claim 10, wherein the housing is paintable to match a wall color where the keypad is mounted.

13. The building automation keypad device of claim 10, further comprising a plurality of labels mounted to the label area, the labels identifying the plurality of function elements.

14. The building automation keypad device of claim 10, wherein the housing overlaps the label area to cover an edge of the label background.

15. The building automation keypad device of claim 10, further comprising an LED corresponding to each of the plurality of function elements, the LED lighting to indicate an activated function element.

16. A method comprising:
receiving an identification signal indicating a function selected at a keypad;
identifying at least one automation device corresponding to the selected function;
receiving a separate identification signal indicating an adjustment to the selected function; and
generating a device command for the at least one automation device based on the indicated adjustment.

17. The method of claim 16, further comprising issuing the device command to the at least one automation device.

18. The method of claim 16, further comprising identifying the selected function to a user.

19. The method of claim 16, wherein generating the device command is based at least in part on input received from at least one sensor.
